(19) United States
(12) Patent Application Publication
(10) Pub. No.: US 2005/0181120 A1
(43) Pub. Date: Aug. 18, 2005

(54) Composition for forming a functional material layer, method for forming a functional material layer, and method for manufacturing a fuel cell, as well as electronic device and automobile

(75) Inventor: Hironori Hasei, Okaya-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/041,450

(22) Filed: Jan. 25, 2005

(30) Foreign Application Priority Data
Feb. 17, 2004 (JP) 2004-040074

(51) Int. Cl. B41J 2/05

(52) U.S. Cl. 427/115

(57) ABSTRACT

The exemplary embodiments provide: a composition for forming a functional material layer that can form a functional material layer of a constant quality for a long time, the composition for forming a functional material layer including a solution of a strong-acid functional material, to which a specific amount of a base is added so as not to corrode components of an ejection device. A method for forming a functional material layer includes the composition onto a substrate using ejection device. A method for manufacturing a fuel cell that has a first current-collecting layer, a first reaction layer, an electrolyte film, a second reaction layer, and a second current-collecting layer, includes forming at least one of the first and the second reaction layers by applying the composition for forming a functional material layer using the ejection device.

### BACKGROUND

The exemplary embodiments relate to a non-corrosive composition for forming a functional material layer to be ejected by an inkjet ejection device (hereinafter referred to as an “ejection device”), such that components of the ejection device do not get corroded; a method for forming the functional material layer by applying the composition onto a substratum using the ejection device; and a method for manufacturing a fuel cell using the forming method, as well as a method for manufacturing the fuel cell as a power source for an electronic device and an automobile.

The related art includes a fuel cell including an electrolyte film; an electrode (anode) placed on one surface of the electrolyte film; another electrode (cathode) formed on the other surface of the electrolyte film; etc. For example, in a solid polymer electrolyte fuel cell whose electrolyte film is a solid polymer electrolyte film, a reaction to separate hydrogen into hydrogen ions and electrons takes place on the anode; the electrons flow toward the cathode; the hydrogen ions travel through the electrolyte film toward the cathode; and a reaction to generate water from an oxygen gas, the hydrogen ions and the electrons takes place on the cathode.

In such a solid electrolyte fuel cell, each electrode is usually formed of: a reaction layer including metal particles that are the reaction catalyst of a reaction gas; a gas diffusion layer, including carbon particles, formed on the substrate side of the reaction layer; and a current-collecting layer, including a conductive substance, formed on the substrate side of the gas diffusion layer. On one substrate, a hydrogen gas, which is uniformly diffused through gaps of the carbon particles forming a gas diffusion layer, makes a reaction on a reaction layer to be separated into electrons and hydrogen ions. The electrons generated are collected onto a current-collecting layer, and the electrons flow toward another current-collecting layer on the other substrate. The hydrogen ions travel, via a polymer electrolyte film, to another reaction layer on the second substrate, where a reaction to generate water from the electrons flowing from the current-collecting layer and the oxygen gas takes place.

In such a fuel cell, there are related methods for forming a reaction layer such as: (a) a method to print a catalyst layer (reaction layer) onto an electrolyte film by applying a paste to form an electrode catalyst layer, which is prepared by mixing a catalyst-supporting carbon into a polymer electrolyte solution and an organic solvent, onto a printing base (polytetrafluoroethylene sheet) and drying the paste, which is bonded to an electrolyte film by thermocompression, followed by removal of the printing base (see Japanese Unexamined Patent Publication No. 8-88008) and (b) a method to apply, using a spray, an electrolyte solution of carbon particles using a spray, the electrolyte solution of carbon particles supporting a solid catalyst onto a carbon layer to be used as an electrode, and then volatilize the solvent (see Japanese Unexamined Patent Publication No. 2002-298860).

However, the above related methods both require a large amount of an expensive catalyst such as platinum particles, etc., which makes the manufacturing cost problematically high. Therefore, to solve or address such a problem, a method to use hexachloroplatinic acid, which is available at a lower cost compared to platinum, as a catalyst has been proposed (see Japanese Unexamined Patent Publication No. 2003-297372).

Yet, the method described in Japanese Unexamined Patent Publication No. 2003-297372, which is to form a reaction layer by depositing platinum by way of chemical plating after contacting hexachloroplatinic (IV) acid to an electrolyte film, still has problem in that it is difficult to obtain a fuel cell having a constant power density because of the incapability in uniform application of the catalyst and precise application of a specified amount of the catalyst at a specified position.

### SUMMARY

A related art technique forms a functional material layer by applying various functional materials using an ejection device.

The inventors of the exemplary embodiments have developed a method for forming a reaction layer by applying a reaction layer-forming material using the ejection device.

However, since a solution of hexachloroplatinic (IV) acid to be used as the reaction layer-forming material is a strong acid, the nozzle heads of the ejection device gradually become corroded and the size and shape of nozzle holes become nonuniform when the solution is repeatedly ejected from the ejection device to form a reaction layer.

Therefore, it becomes difficult to apply a specified amount of the reaction layer-forming material, which triggers another problem of incapability in forming a reaction layer where a catalyst is uniformly dispersed.

The exemplary embodiments address the above and/or other problems, and provide: a composition for forming a functional material layer that, when a functional material layer represented by a reaction layer of a fuel cell is formed using an ejection device, can form a functional material layer of a constant quality for a long time by using a composition for forming a functional material layer that does not corrode the components of the ejection device; a method for forming a functional material layer by applying the composition onto a substratum using an ejection device; and a method for manufacturing a fuel cell using the forming method, as well as an electronic device and an automobile that have the fuel cell obtained by the method for manufacturing a fuel cell as a power source.

As a result of a concentrated study to address or solve the above problems, the inventors of the exemplary embodiments have found that, through the method for manufacturing a fuel cell wherein a reaction layer is formed by applying a reaction layer-forming material using an ejection device, mass production of a fuel cell having a reaction layer of a constant and high quality can be achieved by using a reaction layer-forming material that does not corrode the components of an ejection device. Then, by generalizing the above knowledge, the exemplary embodiments have finally been completed.

Thus, according to a first exemplary embodiment, a non-corrosive composition for forming a functional material layer may be ejected by an ejection device, including a solution of a strong-acid functional material, to which a specific amount of a base is added so as not to corrode the components of an ejection device.

In the composition for forming a functional material layer according to the exemplary embodiments, the solution of a strong-acid functional material is a solution of below pH 2, which further becomes a solution of pH 2 or higher by adding a specific amount of a base.

In the composition for forming a functional material layer according to the exemplary embodiments, ammonia or an organic base is used as the base.

In the composition for forming a functional material layer according to the exemplary embodiments, the composition is a reaction layer-forming composition that forms at least one of a first reaction layer and a second reaction layer of a fuel cell, the fuel cell including a first current-collecting layer; the first reaction layer; an electrolyte film; the second reaction layer; and the second current-collecting layer. Further, the composition is a reaction layer-forming composition that is obtained by adding a specific amount of a base to a strong-acid solution of a platinum group element compound. Furthermore, the composition is a reaction layer-forming composition that is obtained by adding a specific amount of ammonia or an organic base to a solution of hexachloroplatinic acid.

In the composition for forming a functional material layer according to the exemplary embodiments, the components of an ejection device include a metal that has a higher ionization tendency compared to a platinum group element; or a compound of the metal.

With the composition for forming a functional material layer according to the exemplary embodiments, which does not corrode the components of an ejection device, mass production of a functional material layer of a constant quality can be achieved even if the ejection device is used repeatedly for a long time.

A second exemplary embodiment provides a method for forming a functional material layer including the step of applying the non-corrosive composition for forming a functional material layer onto a substratum using an ejection device.

With the method for forming a functional material layer according to the exemplary embodiments, a composition for forming a functional material layer that does not corrode the components of an ejection device is used, thereby mass production of a functional material layer of a constant quality can be achieved even if the ejection device is used repeatedly for a long time.

A third exemplary embodiments provides a method for manufacturing a fuel cell that has a first current-collecting layer; a first reaction layer; an electrolyte film; a second reaction layer; and a second current-collecting layer, the method including the step of forming at least one of the first and the second reaction layers by applying the composition for forming a functional material layer using an ejection device.

With the method for manufacturing a fuel cell according to the exemplary embodiments, a composition for forming a functional material layer that does not corrode the components of an ejection device is used, thereby a reaction layer of a uniform quality can be formed efficiently even if the ejection device is used repeatedly for a long time. Therefore, with the method for manufacturing a fuel cell according to the exemplary embodiment, mass production of a high-quality fuel cell with a constant power density can be achieved at a low cost.

The fourth exemplary embodiment provides an electronic device including a fuel cell as a power source manufactured by the method according to the exemplary embodiment.

With the exemplary embodiment, an electronic device including an earth-conscious clean energy as a power source can be provided.

A fifth exemplary embodiment provides an automobile including a fuel cell as a power source manufactured by the method according to the exemplary embodiment.

With the exemplary embodiment, an automobile including an earth-conscious clean energy as a power source can be provided.

### BRIEF DESCRIPTION OF THE DRAWINGS

FIG. 1 is a schematic of an inkjet ejection device according to an exemplary embodiment;

FIG. 2 is a schematic of a fuel cell-manufacturing line according to an exemplary embodiment;

FIG. 3 is a flow chart of a fuel cell-manufacturing method according to an exemplary embodiment;

FIGS. 4(a) and 4(b) are cross-sectional schematics of a substrate under a manufacturing step of a fuel cell according to an exemplary embodiment;

FIGS. 5(a) and 5(b) are schematics describing a gas passage-forming treatment according to an exemplary embodiment;

FIG. 6 is a cross-sectional schematic of a substrate under a manufacturing step of a fuel cell according to an exemplary embodiment;

FIG. 7 is a cross-sectional schematic of a substrate under a manufacturing step of a fuel cell according to an exemplary embodiment;

FIG. 8 is a cross-sectional schematic of a substrate under a manufacturing step of a fuel cell according to an exemplary embodiment;

FIG. 9 is a cross-sectional schematic of a substrate under a manufacturing step of a fuel cell according to an exemplary embodiment;

FIG. 10 is a cross-sectional schematic of a substrate under a manufacturing step of a fuel cell according to an exemplary embodiment;

FIG. 11 is a cross-sectional schematic of a substrate under a manufacturing step of a fuel cell according to an exemplary embodiment;

FIG. 12 is a cross-sectional schematic of a substrate under a manufacturing step of a fuel cell according to an exemplary embodiment;

FIG. 13 is a cross-sectional schematic of a substrate under a manufacturing step of a fuel cell according to an exemplary embodiment;

FIG. 14 is a cross-sectional schematic of a fuel cell according to an exemplary embodiment; and

FIG. 15 is a schematic of a large fuel cell having laminated fuel cells according to an exemplary embodiment.

### DETAILED DESCRIPTION OF EMBODIMENTS

The exemplary embodiment will now be described with respect to: 1) a composition for forming a functional material layer; 2) a method for forming a functional material layer; 3) a method for manufacturing a fuel cell; 4) an electronic device; and 5) an automobile.

1) A Composition for Forming a Functional Material Layer

A non-corrosive composition for forming a functional material layer according to the exemplary embodiment includes a non-corrosive composition for forming a layer of a functional material ejected by an ejection device, including a solution of a strong-acid functional material, to which a specific amount of a base is added so as not to corrode the components of the ejection device.

The functional material to be used as the composition for forming a functional material layer according to the exemplary embodiments is not especially limited, but must be a strong acid and have a possibility of corroding the components of an ejection device at a contact with the components. For example, materials for forming a reaction layer of a fuel cell, materials for forming a luminous layer of an organic electroluminescence element, etc. are included, especially materials for forming a reaction layer of a fuel cell. A strong-acid solution of a platinum group element compound that is below pH 2 is far more desirable.

The platinum group element compound includes, for example, a compound of one kind or two or more kinds of metals selected from a group including: platinum, rhodium, palladium, ruthenium, osmium, iridium, etc.; as well as alloy including two or more of these. Among the foregoing, hexachloroplatinic (IV) acid is desired.

The solvent to be used as the strong-acid solution of a platinum group element compound includes, but is not limited to: water; alcohols such as methanol, ethanol, propanol, butanol, etc.; hydrocarbon compounds such as n-heptane, n-octane, decane, toluene, xylene, cymene, durene, indene, dipentene, tetrahydronaphthalene, decahydronaphthalene, cyclohexyl benzene, etc.; and ether compounds such as ethylene glycol dimethyl ether, ethylene glycol diethyl ether, ethylene glycol methyl ethyl ether, diethylene glycol dimethyl ether, diethylene glycol diethyl ether, diethylene glycol methyl ethyl ether, 1,2-dimethoxyethane, bis (2-methoxyethyl) ether, p-dioxane, etc. The foregoing materials can be used individually or by mixing two or more of the materials. Among the foregoing, water or a mixed solvent including water and other organic solvents is desired.

The concentration of the solution of a platinum group element compound is not limited but must be a concentration that satisfies a viscosity and a surface tension suitable for ejection of the solution, which is, for example, 1% by weight or higher and 20% by weight or lower.

The viscosity of the solution of a platinum group element compound is not limited, but is, for example, 1 mpa.s or higher and 50 mPa.s or lower. If the viscosity is lower than 1 mPa.s when the solution is ejected using an ejection device, the periphery of nozzle holes becomes easy to be contaminated due to the spillage of the reaction layer-forming material. To the contrary, if the viscosity is higher than 50 mPa.s, the frequency of nozzle hole clogging becomes higher, which prevents or discourages smooth ejection of droplets.

The surface tension of the solution of a platinum group element compound is not limited, but is, for example, within a range of 2 mN/m or higher and 75 mN/m or lower. If the surface tension is lower than 2 mN/m when the solution is ejected using an ejection device, the wettability of the reaction layer-forming material with respect to the nozzle surface is increased, which makes it easier for the droplet-traveling path to be bent. On the other hand, if the surface tension exceeds 75 mN/m, the shape of meniscus at the tip of the nozzle becomes unstable, which makes it difficult to control the ejecting amount and ejecting timing.

The composition for forming a functional material layer according to the exemplary embodiments include a solution of a strong-acid functional material, to which a specific amount of a base is added so as not to corrode the components of an ejection device.

The base to be used is not especially limited, but includes, for example, inorganic bases including: alkali metal hydroxides such as sodium hydroxide, potassium hydroxide, etc.; alkali metal carbonates such as sodium carbonate, potassium carbonate, etc.; alkali metal hydrogen carbonates such as sodium hydrogen carbonate, potassium hydrogen carbonate, etc.; alkali metal hydrides such as sodium hydride, etc.; alkaline-earth metal hydrides such as calcium hydride, etc.; and ammonia.

Organic bases include: primary amines such as methylamine, ethylamine, n-propylamine, aniline, etc.; secondary amines such as dimethylamine, diethylamine, di-n-propylamine, etc.; tertiary amines such as trimethylamine, triethylamine, tri-n-propylamine, etc.; and nitrogenous heterocyclic compounds such as pyridine, etc.

Among the foregoing materials, use of ammonia or an organic base is preferable in terms of post-treatment, handling, and cost.

The amount of a base to be added is not limited but must be an amount that can obtain a composition for forming a functional material layer that does not corrode the components of an ejection device, more specifically, an amount that can obtain a composition for forming a functional material layer of pH 2 or higher by adding the base to a strong-acid solution of a functional material that is below pH 2.

The method for adding a base to the solution of a functional material is not limited. For example, a method to add a solution of a base to the solution of a functional material while being stirred; a method for giving a gaseous base into the solution of a functional material; a method to add a solid base to the solution of a functional material; etc. are included. Among the foregoing methods, the method to add a solution of a base to the solution of a functional material while being stirred is preferable, from the viewpoints of operability, etc.

The ejection device as a subject matter of the exemplary embodiments is not limited but must be an inkjet ejection device. For example, an ejection device employing a thermal method, the droplets being ejected by generating air bubbles by way of thermal foaming; an ejection device employing a piezo method, the droplets being ejected by way of compression using piezo elements; etc. are included.

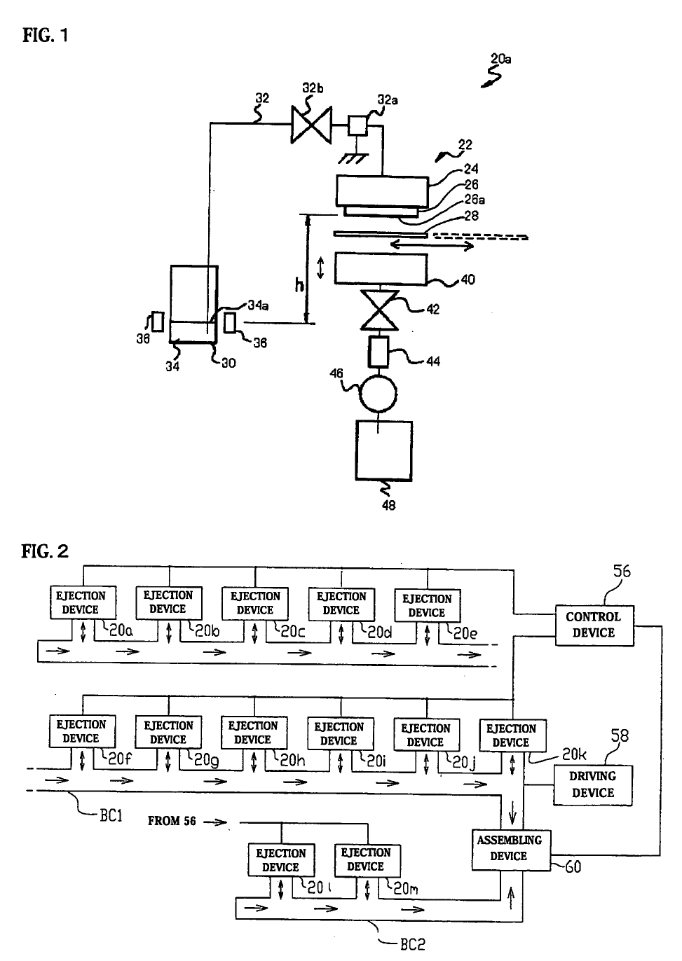

An example of the ejection device as a subject matter of the exemplary embodiments is shown in FIG. 1. An ejection device 20a includes: a tank 30 that stores an ejection material 34; an inkjet head 22 coupled to the tank 30 via an ejection material carrier pipe 32; a table 28 that loads and carries an ejected material; a suction cap 40 that sucks the excess of the ejection material 34 that is accumulated in the inkjet head 22 and removes the excessive ejection material from the inside of the inkjet head 22; and a waste fluid tank 48 that stores the excessive ejection material sucked by the suction cap 40.

The tank 30, which stores the ejection material 34 of the composition to form a functional material layer according to the exemplary embodiments, etc., has a fluid level control sensor 36 for controlling the height of a level 34a of the ejection material stored in the tank 30. The fluid level control sensor 36 performs a control to maintain the height difference h (hereinafter referred to as the water head value) between an end-piece 26a of a nozzle-forming surface 26 provided on the inkjet head 22 and the level 34a in the tank 30. For example, by controlling the height of the level 34a so that the water head value falls within a range of 25 mm±0.5 mm, the ejection material 34 in the tank 30 can be carried to the inkjet head 22 at a pressure within a specified range. By carrying the ejection material 34 at a pressure within a specified range, a necessary amount of the ejection material 34 can be ejected stably from the inkjet head 22.

The ejection material carrier pipe 32 includes: an ejection material passage-grounding joint 32a that prevents electrification in the passage of the ejection material carrier pipe 32; and a head air bubble-removing valve 32b. The head air bubble-removing valve 32b is used for sucking the ejection material in the inkjet head 22 using the suction cap 40, which is described later.

The inkjet head 22, which has a head body 24 and the nozzle-forming surface 26, a number of nozzles that eject the ejection material being formed, ejects a composition for forming a functional material layer, etc. to be applied onto a substrate when a gas passage for supplying, for example, a reaction gas is formed on the substrate.

The table 28 is installed so as to be movable in a specified direction. By moving in the arrow direction shown in FIG. 1, the table 28 loads a substrate carried by a belt conveyor BC1 and takes the substrate into the ejection device 20a.

The suction cap 40, which is movable in the arrow direction shown in FIG. 1, is configured to be able to seal a plurality of nozzles from the outside air by closely overlapping with the nozzle-forming surface 26 so as to surround the nozzles on the nozzle-forming surface 26, and thus forming a sealed space between the suction cap 40 and the nozzle-forming surface 26. That is, when the ejection material in the inkjet head 22 is sucked by the suction cap 40, the flow rate of the ejection material to be sucked can be increased and the air bubbles in the inkjet head 22 can be discharged rapidly by sucking with the suction cap 40, with the head air bubble-removing valve 32b closed so as not to let the ejection material flow in from the tank 30.

In a passage provided under the suction cap 40, a suction valve 42 is provided. The suction valve 42 plays a role to close the passage for the purpose of shortening the time to take a pressure balance (atmospheric pressure) between the suction side under the suction valve 42 and the side of the inkjet head 22 above the suction valve 42. In the passage, a suction pump 46 includes: a suction pressure detection sensor 44 for detecting sucking abnormalities; a tube pump; etc., is provided. Further, the ejection material 34 sucked and carried by the suction pump 46 is temporarily stored in the waste fluid tank 48.

The components of the ejection device as a subject matter of the exemplary embodiments include: a metal that has a higher ionization tendency compared to the platinum group element of the platinum group element compound that is included in the composition for forming a functional material layer; or a compound of the metal. For example, the surface of the inkjet head is formed of a mixture of: polytetrafluoroethylene, and nickel or a compound of nickel, which has a higher ionization tendency than the platinum group element.

In the composition for forming a functional material layer according to the exemplary embodiments, which can be prepared by adding a base to a solution of a functional material, an operation to add the base to the solution of a functional material can be performed in any step but before ejecting the composition for forming a functiorial material layer from ejection nozzles of an ejection device. For example, the operation can be performed in the tank 30 before sucking the reaction layer-forming material using the ejection material carrier pipe 32; or in another tank that can be provided halfway on the ejection material carrier pipe 32 so as to adjust the pH value.

The composition for forming a functional material layer according to the exemplary embodiments is a reaction layer-forming composition that forms at least one of a first and a second reaction layers of a fuel cell, the fuel cell including the first current-collecting layer; the first reaction layer; an electrolyte film; the second reaction layer; and the second current-collecting layer. Here, the composition is obtained by adding a specific amount of a base to a strong-acid solution of a platinum group element compound. Further, the composition is obtained by adding a specific amount of ammonia or an organic base to a solution of hexachloroplatinic acid. Furthermore, the components of an ejection device include: a metal that has a higher ionization tendency compared to a platinum group element; or a compound of the metal.

With the composition for forming a functional material layer according to the exemplary embodiments, which does not corrode the components of an ejection device even at a contact with the components, mass production of a functional material of a constant quality can be achieved for a long time.

2) A Method for Forming a Functional Material Layer

The second exemplary embodiment is a method for forming a functional material layer including the step of applying the non-corrosive composition for forming a functional material layer using an ejection device onto a substratum.

The substratum is not especially limited but must be able to support the functional material layer.

When the functional material layer obtained by the method according to the is the first or the second reaction layer of a fuel cell that includes: the first current-collecting layer; the first reaction layer; an electrolyte film; the second reaction layer; and the second current-collecting layer, the first current-collecting layer or the electrolyte film becomes the substratum.

With the method for forming a functional material layer according to the exemplary embodiments, when the composition for forming a functional material layer being used does not corrode the components of an ejection device even at a contact with the components, mass production of a reaction layer of a uniform quality can be achieved efficiently for a long time.

3) A Method for Manufacturing a Fuel Cell

The third exemplary embodiment is a method for manufacturing a fuel cell that has the first current-collecting layer; the first reaction layer; an electrolyte film; the second reaction layer; and the second current-collecting layer, the method including the step of forming at least one of the first and the second reaction layers by applying the composition for forming a functional material layer using an injection device.

The method for manufacturing a fuel cell according to the exemplary embodiments can be implemented by using a fuel cell-manufacturing device (fuel cell-manufacturing line) shown in FIG. 2. The fuel cell-manufacturing line shown in FIG. 2 includes: ejection devices 20a to 20m, each of which is used in each manufacturing step; the belt conveyor BC1 that couples the ejection devices 20a to 20k; a belt conveyor BC2 that couples the ejection devices 20l and 20m; a driving device 58 that drives the belt conveyors BC1 and BC2; an assembling device 60 that assembles fuel cells; and a control device 56 that controls the entire fuel cell-manufacturing line.

The ejection devices 20a to 20k are placed in line at specified intervals along the belt conveyor BC1, and the ejection devices 20l and 20m are placed in line at specified intervals along the belt conveyor BC2. Further, the control device 56 is coupled to the ejection devices 20a to 20k, the driving device 58, and the assembling device 60.

In the fuel cell-manufacturing line, the belt conveyor BC1 driven by the driving device 58 is driven to perform a treatment in each of the ejection devices 20a to 20k by carrying a substrate of a fuel cell (hereinafter referred to as simply a “substrate”) to each of the ejection devices 20a to 20k. Likewise, the belt conveyor BC2 is driven based on a signal from the control device 56 to perform a treatment in the ejection devices 20l and 20m by carrying a substrate to each of the ejection devices 20l and 20m. Further, in the assembling device 60, fuel cell assembly is performed using the substrate carried by the belt conveyors BC1 and BC2 based on a control signal from the control device 56.

In the present exemplary embodiment, a device shown in FIG. 1 is used as the ejection device 20a. Further, the ejection devices 20b to 20m have the same configuration as the ejection device 20a but the type of the ejection material 34 is different. Therefore in the following, the same reference numerals are used for describing the same configurations of each ejection device.

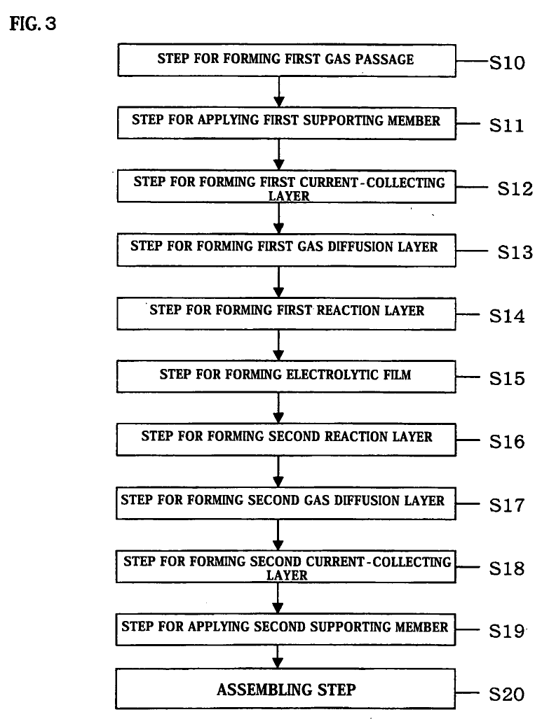

Next, each step of the fuel cell-manufacturing method using the fuel cell-manufacturing line shown in FIG. 2 will now be described. FIG. 3 shows a flow chart of the fuel cell-manufacturing method using the fuel cell-manufacturing line shown in FIG. 2.

As shown in FIG. 3, the fuel cell is manufactured by: forming a gas passage on the first substrate (as shown in step S10, a step for forming first gas passage); applying the first supporting member into the gas passage (as shown in step S11, step for applying first supporting member); forming the first current-collecting layer (as shown in S12, step for forming first current-collecting layer); forming the first gas diffusion layer (as shown in S13, step for forming first gas diffusion layer); forming the first reaction layer (as shown in S14, step for forming first reaction layer); forming an electrolyte film (as shown in S15, step for forming electrolyte film); forming the second reaction layer (as shown in S16, step for forming second reaction layer); forming the second gas diffusion layer (as shown in S17, step for forming second gas diffusion layer); forming the second current-collecting layer (as shown in S18, step for forming second current-collecting layer); applying the second supporting member into the second gas passage (as shown at step S19, step for applying second supporting member); and laminating the second substrate on which the second gas passage is formed (as shown in S20, assembling step).

Step for Forming First Gas Passage (S10)

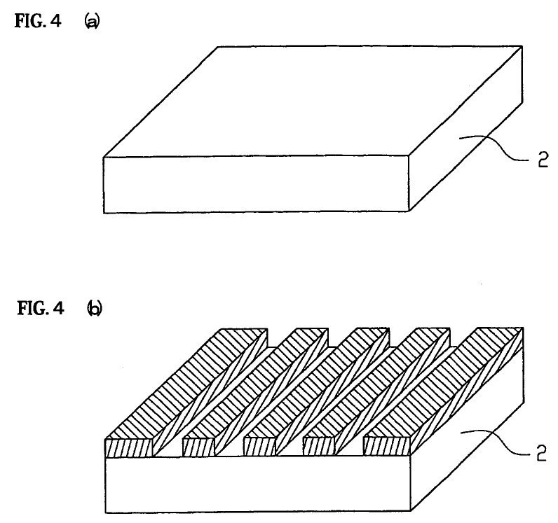

First, as shown in FIG. 4(a), the first rectangular substrate 2 is prepared and carried to the ejection device 20a using the belt conveyor BC1. The substrate 2 is not especially limited and can be any substrate, such as a silicon substrate, etc., to be used for a usual fuel cell. In the present exemplary embodiment, a silicon substrate is used.

Referring to FIGS. 1-4(b), the substrate 2 carried by the belt conveyor BC1, is loaded onto the table 28 of the ejection device 20a and taken into the ejection device 20a. In the ejection device 20a, a photoresist liquid stored in the tank 30 of the ejection device 20a is applied, via the nozzles on the nozzle-forming surface 26, at a specified position on the substrate 2 loaded on the table 28, and thus a photoresist pattern (shown hatched in FIG. 4(b)) is formed on the surface of the substrate 2. The photoresist pattern is formed in a region on the surface of the substrate 2 avoiding a region where the first gas passage for supplying the first reaction gas is to be formed, as shown in FIG. 4(b).

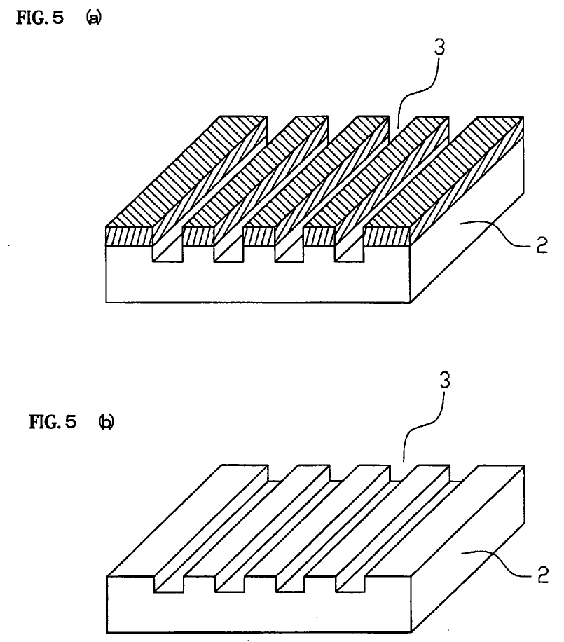

The substrate 2, on which a photoresist pattern is formed at a specified position, is carried to the ejection device 20b by the belt conveyor BC1, loaded on the table 28 of the ejection device 20b, and taken into the ejection device 20b. In the ejection device 20b, an etching liquid such as a hydrofluoric acid solution, etc. stored in the tank 30 is applied onto the surface of the substrate 2 via the nozzles on the nozzle-forming surface 26. With the etching liquid, the surface of the substrate 2, except the region where the photoresist pattern is formed, is etched, and a first gas passage 3 in an open-top square shape, when viewed cross-sectionally, is formed stretching from one side of the substrate 2 to the other side, as shown in FIG. 5(a). Further, as shown in FIG. 5(b), the surface of the substrate 2 on which the gas passage 3 is formed is cleansed by a cleansing device, which is not illustrated, and the photoresist pattern is removed. Then, the substrate 2 on which the gas passage 3 is formed is moved from the table 28 to the belt conveyor BC1 and carried to the ejection device 20c by the belt conveyor BC1.

Step for Applying First Supporting Member (S11)

Next, on the substrate 2 on which the gas passage is formed, the first supporting member for supporting the first current-collecting layer is applied into the gas passage. The application of the first supporting member is performed by: loading the substrate 2 on the table 28; taking the substrate 2 into the ejection device 20c; and ejecting, using the ejecting device 20c, the first supporting member 4 stored in the tank 30, via the nozzles on the nozzle-forming surface 26, into the first gas passage formed on the substrate 2.

The first supporting member to be used is not especially limited but must be inert to the first reaction gas; prevent or inhibit the first current-collecting layer from falling into the first gas passage 3; and not prevent or inhibit the first reaction gas from diffusing onto the first reaction layer, for example, carbon particles, glass particles, etc. are included. In the present exemplary embodiment, porous carbons with a particle diameter of approximately 1 to 5 microns are used. By using porous carbons with a specified particle diameter as the supporting member, the flow of the reaction gas is never hindered because the reaction gas supplied via the gas passage is diffused upward through the gaps between porous carbons.

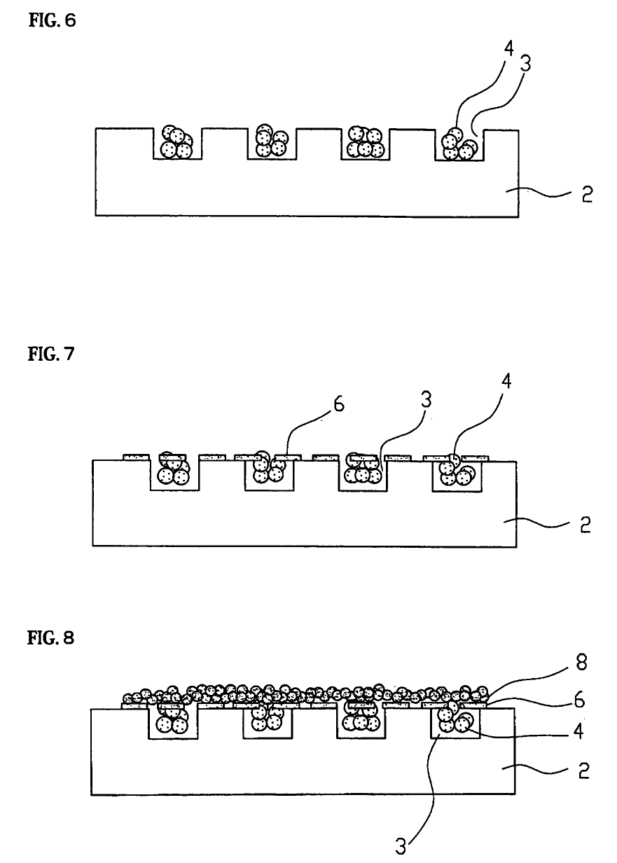

FIG. 6 shows a cross-sectional view of the substrate 2 on which a first supporting member 4 is applied. The substrate 2 on which the first supporting member 4 is applied is moved from the table 28 to the belt conveyor BC1 and carried to the ejection device 20d by the belt conveyor BC1.

Step for Forming First Current-Collecting Layer (S12)

Next, the first current-collecting layer for collecting electrons generated in a reaction caused by the first reaction gas is formed on the substrate 2. First, the substrate 2 carried to the ejection device 20d by the belt conveyor BC1 is loaded on the table 28 and taken into the ejection device 20d. In the ejection device 20d, the first current-collecting layer having a specified pattern on is formed by ejecting, via the nozzles on the nozzle-forming surface 26, a specified amount of a material for forming a current-collecting layer stored in the tank 30 onto the substrate 2.

The current-collecting layer-forming material to be used is not especially limited but must be a material including a conductive substance.

The conductive substance includes, for example, copper, silver, gold, platinum, aluminum, etc. The foregoing substances can be used individually or by combining two or more. The current-collecting layer-forming material can be prepared by dispersing at least one of the above conductive substances into an appropriate solvent and adding a dispersant according to need.

In the exemplary embodiment, since the application of the current-collecting layer-forming material is performed using the ejection device 20d, a specified amount can be applied precisely at a specified position by an easy operation. Therefore, the consumption of the current-collecting layer-forming material can be saved substantially, which enables an efficient formation of a current-collecting layer in a desired pattern (shape).

FIG. 7 shows a cross-sectional view of the substrate 2 on which a first current-collecting layer 6 is formed. As shown in FIG. 7, the first current-collecting layer 6 is supported by the first supporting member 4 in the first gas passage formed on the substrate 2, which prevents the first current-collecting layer 6 from falling into the first gas passage. The substrate 2 on which the first current-collecting layer 6 is formed is moved from the table 28 to the belt conveyor BC1 and carried to the ejection device 20e by the belt conveyor BC1. Step for forming first gas diffusion layer (S13)

Next, the first gas diffusion layer is formed on the current-collecting layer of the substrate 2. First, the substrate 2 carried to the ejection device 20e by the belt conveyor BC1 is loaded on the table 28 and taken into the ejection device 20e. In the ejection device 20e, the first gas diffusion layer is formed by ejecting, via the nozzles on the nozzle-forming surface 26, a material for forming a gas diffusion layer stored in the tank 30 of the ejection device 20e onto a specified position on the surface of the substrate 2 loaded on the table 28.

As the gas diffusion layer-forming material to be used, which is generally carbon particles, materials such as carbon nanotubes, carbon nanohorns, fullerene, etc. can also be used. Further, carbon particles can be used on the substrate side of the gas diffusion layer, and another material having an excellent catalyst-supporting ability in spite of a low gas-diffusing ability can be used on the top surface of the gas diffusion layer.

FIG. 8 shows a cross-sectional view of the substrate 2 on which a first gas diffusion layer 8 is formed. As shown in FIG. 8, the first gas diffusion layer 8 is formed on the entire surface of the substrate 2 so as to cover the first current-collecting layer formed on the substrate 2. The substrate 2 on which the first gas diffusion layer 8 is formed is moved from the table 28 to the belt conveyor BC1 and carried to the ejection device 20f.

Step for Forming First Reaction Layer (S14)

Next, the first reaction layer is formed on the substrate 2. The first reaction layer is formed so as to be electrically coupled to the first current-collecting layer via the gas diffusion layer 8.

First, the substrate 2 carried to the ejection device 20f by the belt conveyor BC1 is loaded on the table 28 and taken into the ejection device 20f. Next, a specified amount of a reaction layer-forming composition stored in the tank 30 of the ejection device 20f is ejected onto a portion for forming the first reaction layer on the surface of the substrate 2, which forms a coating film of a reaction layer-forming composition. Then, by baking the coating film in an inert atmosphere, the reaction layer is formed.

The reaction layer-forming composition to be used is a solution or a dispersion liquid, which is pH 2 or higher, of a platinum group element compound that is obtained by adding a specified base to a strong-acid solution or a dispersion liquid, which is below pH 2, of a platinum group element compound in order to prevent the components of the ejection device from corroding at a contact between the composition and the components used.

The reaction layer-forming composition can be prepared in the same manner as the method described in the section of the composition for forming a functional material layer.

After the coating film of the reaction layer-forming material is formed by applying the reaction layer-forming material using the ejection device 20f, baking is performed under an inert gaseous atmosphere so as to develop a sufficient activity as a catalyst. By performing baking, the first reaction layer 10 can be obtained.

The method for baking the coating film of the reaction layer-forming material includes: a method to remove the unnecessary part of the coating film by heating at an atmospheric pressure under an inert gaseous atmosphere; a method to remove the unnecessary part by heating at a reduced pressure; etc., the latter of which is preferable. The lower the heating temperature is, the more preferable the method is considered. A temperature of 100° C. or lower is more preferable, and a temperature of 50° C. or lower is far more preferable. In addition, it is preferred to remove the unnecessary part in as short time as possible. This is because a long-time removal of the unnecessary part at a high temperature destroys the uniformity in dispersion condition of the platinum group element compound made by the ejection device, and therefore a reaction layer having a uniformly dispersed catalyst metal cannot be formed.

FIG. 9 shows a cross-sectional view of the substrate 2 on which the first reaction layer 10 is formed as described above. The substrate 2 on which the first reaction layer 10 is formed is moved from the table 28 to the belt conveyor BC1 and carried to the ejection device 20g by the belt conveyor BC1.

Step for Forming Electrolyte Film (SI 5)

Next, an electrolyte film is formed on the substrate 2 on which the first reaction layer 10 is formed. First, the substrate 2 carried to the ejection device 20g by the belt conveyor BC1 is loaded on the table 28 and taken into the ejection device 20g. In the ejection device 20g, an electrolyte film 12 is formed by ejecting, via the nozzles on the nozzle-forming surface 26, a material for forming an electrolyte film stored in the tank 30 onto the first reaction layer 10.

The electrolyte film-forming material to be used includes, for example: a polymer electrolyte material obtained by the micellization of perfluorosulphonic acid such as NAFION® (a registered trademark owned by E.I. DuPont De Nemours and Company Corporation) in a mixed solution of water and methanol with a weight ratio of 1:1; a material made from a ceramic solid electrolyte such as tungstophosphoric acid, molybdophosphoric acid, etc. by giving a specified viscosity (20 cP or lower, for example); etc.

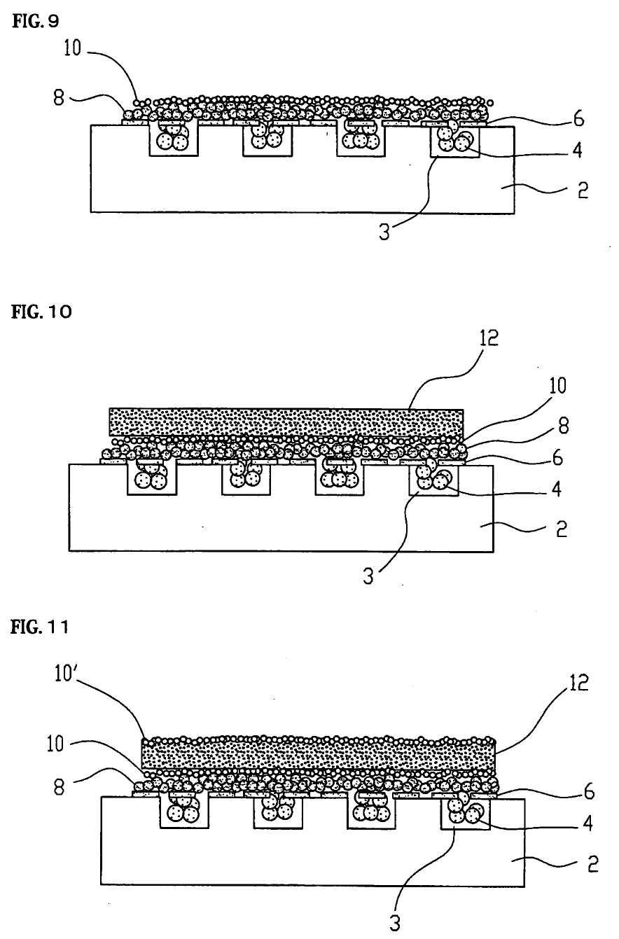

FIG. 10 shows a cross-sectional view of the substrate 2 on which the electrolyte film is formed. As shown in FIG. 10, the electrolyte film 12 having a specified thickness is formed on the first reaction layer 10. The substrate 2 on which the electrolyte film 12 is formed is moved from the table 28 to the belt conveyor BC1 and carried to the ejection device 20h by the belt conveyor BC1.

Step for Forming Second Reaction Layer (S16)

Next, the second reaction layer is formed on the substrate 2 on which the electrolyte film 12 is formed. The second reaction layer is formed by applying, onto the substrate on which the gas passage and the gas diffusion layer is formed, a reaction layer-forming material while giving a flow of an inert gas into the gas passage.

First, the substrate 2 carried to the ejection device 20h by the belt conveyor BC1 is loaded on the table 28 and taken into the ejection device 20h. In the ejection device 20h, the second reaction layer 10′ is formed in the same manner as performed in the ejection device 20f. The material for forming the second reaction layer 10′ can be the same as that used for the first reaction layer.

FIG. 11 shows an cross-sectional view of the substrate 2 on which the second reaction layer 10′ is formed on the electrolyte film 12. As shown in FIG. 11, the second reaction layer 10′ is formed on the electrolyte film 12. On the second reaction layer 10′, a reaction of the second reaction gas takes place. The substrate 2 on which the second reaction layer 10′ is formed is moved from the table 28 to the belt conveyor BC1 and carried to the ejection device 20i by the belt conveyor BC1.

Step for Forming Second Gas Diffusion Layer (S17)

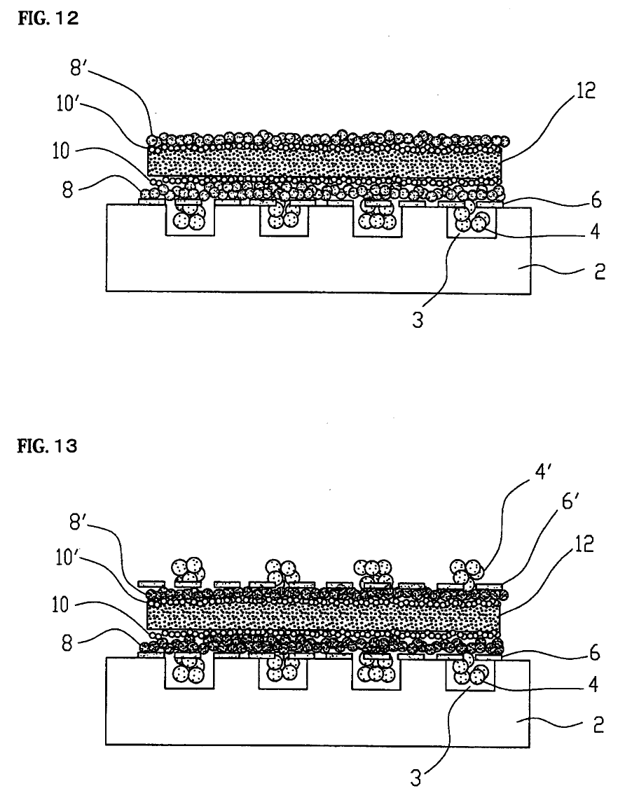

Next, the second gas diffusion layer is formed on the substrate 2 on which the second reaction layer 10′ is formed. First, the substrate 2 carried to the ejection device 20i by the belt conveyor BC1 is loaded on the table 28 and taken into the ejection device 20i. In the ejection device 20i, the second gas diffusion layer 8′ is formed in the same manner as performed in the ejection device 20e. The material for forming the second gas diffusion layer can be the same as that used for the first gas diffusion layer 8. FIG. 12 shows a cross-sectional view of the substrate 2 on which the second gas diffusion layer 8′ is formed on the second reaction layer 10′. The substrate 2 on which the second gas diffusion layer 8′ is formed is moved from the table 28 to the belt conveyor BC1 and carried to the ejection device 20j by the belt conveyor BC1.

Step for Forming Second Current-Collecting Layer (S18)

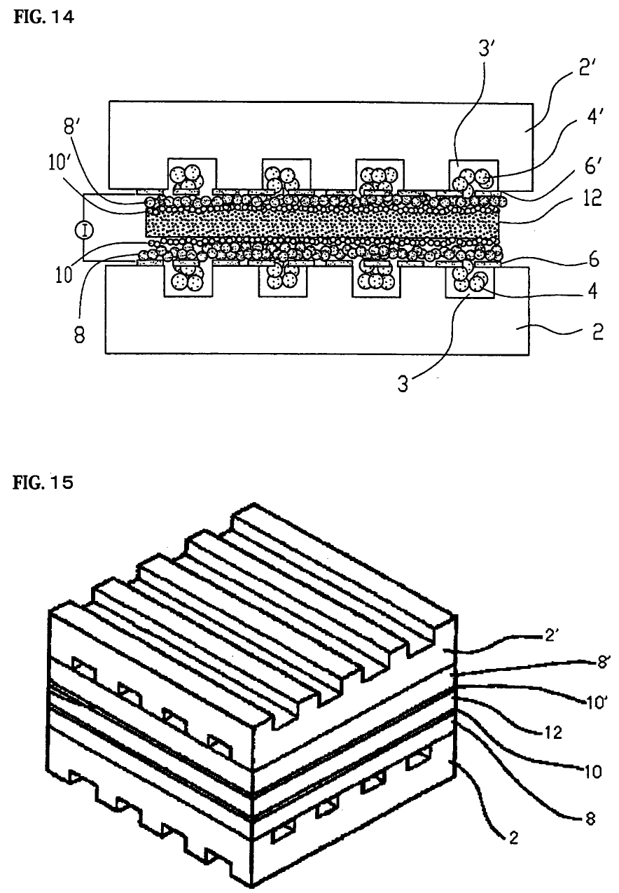

Next, the second current-collecting layer is formed on the substrate 2 on which the second gas diffusion layer 8′ is formed. First, the substrate 2 carried to the ejection device 20j by the belt conveyor BC1 is loaded on the table 28 and taken into the ejection device 20j. Then, the second current-collecting layer 6′ is formed on the second gas diffusion layer 8′ in the same manner as performed in the ejection device 20d (see FIG. 13). The material for forming the second current-collecting layer can be the same as that used for the first current-collecting layer. The substrate 2 on which the second current-collecting layer 6′ is formed is moved from the table 28 to the belt conveyor BC1 and carried to the ejection device 20k by the belt conveyor BC1.

Step for Applying Second Supporting Member (S19)

Next, the substrate 2 carried to the ejection device 20k by the belt conveyor BC1 is loaded on the table 28 and taken into the ejection device 20k. Then, the second supporting member is applied in the same manner as performed in the ejection device 20c. The second supporting member can be the same material used for the first supporting member.

FIG. 13 shows a cross-sectional view of the substrate 2 on which the second current-collecting layer 6′ and the second supporting member 4′ are applied. The second supporting member 4′, which is formed on the second current-collecting layer 6′, is applied at a position to be housed in the second gas passage formed on the second substrate to be laminated on the substrate 2.

Assembling Step (S20)

Next, the substrate 2 on which the second supporting member 4′ is applied is laminated with the separately prepared second substrate on which the second gas passage is formed. The lamination of the substrate 2 (the first substrate) and the second substrate is performed by bonding so that the second supporting member 4′ formed on the substrate 2 is housed in the second gas passage formed on the second substrate. Here, the second substrate can be the same as the material used for the first substrate. Further, the formation of the second gas passage is performed, in the ejection devices 20l and 20m, in the same manner as performed in the ejection devices 20a and 20b.

As described above, a fuel cell having a configuration shown in FIG. 14 can be manufactured. The fuel cell shown in FIG. 14 is configured of: the first substrate 2; the first gas passage 3 formed on the first substrate 2; the first supporting member 4 housed in the first gas passage 3; the first current-collecting layer 6 formed on the first substrate 2 and the first supporting member 4; the first gas diffusion layer 8; the first reaction layer 10 formed on the first gas diffusion layer 8; the electrolyte film 12; the second reaction layer 10′; the second gas diffusion layer 8′; the second current-collecting layer 6′; the second gas passage 3′; the second supporting member 4′ housed in the second gas passage 3′; and the second substrate 2′, from the bottom in FIG. 14. Further, in the fuel cell shown in FIG. 14, the substrate 2′ is placed so that the first gas passage 3 in an open-top square shape, which is formed on the substrate 2 and stretches from one side to the other side, and the second gas passage 3, which is formed on the substrate 2′, are positioned in parallel.

The type of the fuel cell manufactured in the exemplary embodiment is not especially limited. For example, polymer electrolyte fuel cells, phosphoric acid fuel cells, direct methanol fuel cells, etc. are included.

The fuel cell manufactured according to the exemplary embodiment operates as follows. That is, the first reaction gas is introduced through the first gas passage 3 on the first substrate 2 and diffused uniformly by the gas diffusion layer 8; the diffused first reaction gas reacts on the first reaction layer 10 and generates ions and electrons; the generated electrons are collected on the current-collecting layer 8 and flow into the second current-collecting layer 6′ on the second substrate 2′; and the ions generated from the first reaction gas travel through the electrolyte film 12 toward the second reaction layer 8′. On the other hand, the second reaction gas is introduced through the gas passage 3′ on the second substrate 2′ and diffused uniformly by the second gas diffusion layer 8′; and the diffused second reaction gas reacts to the ions traveled through the electrolyte film 12 and the electrons sent from the second current-collecting layer 6′. For example, when the first reaction gas is a hydrogen gas and the second reaction gas is an oxygen gas, a reaction of H₂→2H++2e⁻ takes place on the first reaction layer 10, and another reaction of ½O₂+2H++2e⁻→H₂O takes place on the second reaction layer 10′.

In the method for manufacturing a fuel cell according to the above exemplary embodiment, ejection devices are used in all the steps. However, a fuel cell can also be manufactured by the same steps as those in the conventional method except the steps of applying a reaction layer-forming material and forming the first reaction layer and/or the second reaction layer using ejection devices. Even in such a case, the cost for manufacturing a fuel cell can be kept at a low level because the reaction layer can be formed without using a micro electro mechanical system (MEMS).

In the manufacturing method according to the above exemplary embodiment, a gas passage is formed by forming a photoresist pattern on a substrate, applying a hydrofluoric acid solution, and then performing etching. However, the gas passage can also be formed: without forming a photoresist pattern; by loading a substrate in a fluorine gas atmosphere and then ejecting water to a specified position on the substrate; or by applying a gas passage-forming material on a substrate using an ejection device.

In the manufacturing method according to the above exemplary embodiment, a fuel cell is manufactured by forming the components of the fuel cell on the first substrate first and laminating the second substrate last. However, the manufacturing of a fuel cell can be started from the substrate to which the second reaction gas is supplied.

In the manufacturing method according to the above exemplary embodiment, the second supporting member is applied along the first gas passage formed on the first substrate. However, the second supporting member can also be applied in a direction crossing the first gas passage. That is, the second supporting member can be applied in a direction, for example, stretching from the right side to the left side in FIG. 5B so as to perpendicularly cross the gas passage formed on the first substrate. In such a case, a fuel cell having a configuration wherein the second gas passage formed on the second substrate is placed so as to perpendicularly cross the first gas passage formed on the first substrate can be obtained.

In the manufacturing method according to the above exemplary embodiment, the first current-collecting layer, the first reaction layer, an electrolyte film, the second reaction layer, and the second current-collecting layer are formed, in the described order, on the first substrate on which the first gas passage is formed. However, a fuel cell can also be manufactured by forming the current-collecting layers, the reaction layers, and an electrolyte film on each of the first substrate and the second substrate first, and bonding the first substrate and the second substrate last.

In the fuel cell-manufacturing line according to the present exemplary embodiment, a manufacturing line wherein the first manufacturing line for performing treatments on the first substrate and the second manufacturing line for performing treatments on the second substrate are provided for simultaneous performance of the treatments in both manufacturing lines is employed. Therefore, a fuel cell can be manufactured rapidly because the treatments on the first substrate and the treatments on the second substrate can be performed simultaneously.

Further, with the manufacturing method according to the exemplary embodiments, a large fuel cell can also be manufactured by laminating a plurality of fuel cells. That is, as shown in FIG. 15, a large fuel cell can be manufactured by: further forming a gas passage on the back surface of the substrate 2′ of the manufactured fuel cell; forming a gas diffusion layer, a reaction layer, an electrolyte film, etc. in the same manner as in the manufacturing steps according to the above fuel cell-manufacturing method; and laminating the fuel cells. The large fuel cell obtained as describe above is available as a power source of an automobile, which is described later.

4) An Electronic Device

The electronic device according to the exemplary embodiments can include a fuel cell, as a power source, obtained by the fuel cell-manufacturing method according to the exemplary embodiments. The electronic device includes cellular phones, PHS's, mobiles, notebook personal computers, PDA's (personal digital assistances), portable videophones, etc. Further, the electronic device according to the exemplary embodiments can include other functions such as, for example, a game function, a data communication function, a sound-recording/playing function, a dictionary function, etc.

With the exemplary embodiments, an electronic device including an earth-conscious clean energy as a power source can be provided at a low cost and a high quality.

5) An Automobile

The automobile according to the exemplary embodiments includes a fuel cell, as a power source, obtained by the fuel cell-manufacturing method according to the exemplary embodiments.

With the exemplary embodiment, an automobile including an earth-conscious clean energy as a power source can be provided at a low cost and a high quality.

1. A non-corrosive composition for forming a functional material layer to be ejected by an ejection device, the composition comprising:
a specific amount of a base; and
a solution of a strong-acid functional material, the specific amount of the base being added to the solution so as not to corrode components of the ejection device.

2. The composition for forming a functional material layer according to claim 1, the solution of a strong-acid functional material being a solution of below pH 2, which further becomes a solution of pH 2 or higher by adding the specific amount of the base.

3. The composition for forming a functional material layer according to claim 1, ammonia or an organic base being used as the base.

4. The composition for forming a functional material layer according to claim 1, the composition being a reaction layer-forming composition that forms at least one of a first reaction layer and a second reaction layer of a fuel cell, the fuel cell comprising:
a first current-collecting layer;
the first reaction layer;
an electrolyte film;
the second reaction layer; and
a second current-collecting layer.

5. The composition for forming a functional material layer according to claim 4, the composition being a reaction layer-forming composition that is obtained by adding the specific amount of the base to a strong-acid solution of a platinum group compound.

6. The composition for forming a functional material layer according to claim 4, the composition being a reaction layer-forming composition that is obtained by adding a specific amount of ammonia or an organic base to a solution of hexachloroplatinic acid.

7. The composition for forming a functional material layer according to claim 5, the components of an ejection device comprising:
at least one of a metal that has a higher ionization tendency compared to a platinum group element; and a compound of the metal.

8. A method for forming a functional material layer, comprising:
applying the non-corrosive composition for forming the functional material layer according to claim 1 onto a substratum, using an ejection device.

9. A method for manufacturing a fuel cell including a first current-collecting layer, a first reaction layer, an electrolyte film, a second reaction layer, and a second current-collecting layer, the method comprising:
forming at least one of the first and the second reaction layers by applying the composition for forming a functional material layer according to claim 4, using an ejection device.

10. An electronic device, comprising:
a fuel cell manufactured by the method according to claim 9, the fuel cell being a power source.

11. An automobile, comprising:
a fuel cell manufactured by the method according to claim 9, the fuel cell being a power source.
